(19) United States
(12) Patent Application Publication
(10) Pub. No.: US 2007/0125856 A1
(43) Pub. Date: Jun. 7, 2007

(54) Card reader with wireless transmission

(75) Inventor: Chuan-Lin Hu, Taipei Hsien (TW)

Correspondence Address: BACON & THOMAS, PLLC, 625 SLATERS LANE, FOURTH FLOOR, ALEXANDRIA, VA, 22314, US

(73) Assignee: CHANT SINCERE CO., LTD., Taipei Hsien (TW)

(21) Appl. No.: 11/291,876

(22) Filed: Dec. 2, 2005

(51) Int. Cl. G06K 7/08; G06K 7/06

(52) U.S. Cl. 235/451; 235/441

(57) ABSTRACT

A card reader with wireless transmission comprises a circuit board and a wireless transmission control chip on the circuit board. The circuit board 11 further includes a connector for a data transmission line whose free end is provided with a plug to be inserted into a USB port attached onto a computer main board. The card reader is further provided with at least memory-card insertion slot, whereby the control chip will send and receive radio signals through a plastic case partially extended out of the outer surface of the computer, without being shielded. The card reader with wireless transmission has a further advantage of not occupying an external USB port.

### BACKGROUND OF THE INVENTION

(a) Field of the Invention

The present invention relates to card readers, more particularly to a card reader with wireless transmission realized by including a wireless transmission control chip installed on a circuit board of the card reader, whereby a USB port can be saved.

(b) Description of the Prior Art

The wireless transmission control chips utilizing specifications including Bluetooth, UWB, ZigBee, Wi-Fi, NFC and even WiMAX (with a range over 50 kilometers) have become indispensable in the wireless communication market as the technology is evolving into wideband communication. Among them, Bluetooth and Wi-Fi are the earliest.

A Bluetooth dongle using a USB computer port of the prior art is an external device connected to a computer through one of the computer's USB ports, whereby the computer not having the Bluetooth transmission capability will exchange data wirelessly with a surrounding Bluetooth device, for example, a keyboard, a mouse, a earphone and a PDA. It can relax the computer from restriction of wired data transmission and therefore enhance the convenience of a traditional computer.

The above mentioned Bluetooth dongle of the prior art adopts an external insertion means of using a USB port of a computer, which not only has a high production cost but also occupies a USB port (connected to the main board of the computer).

Further, the computer main board is enclosed within a metallic case, which will produce a shielding effect against the radio transmission of a control chip integrated on the main board. Therefore, the effect of wireless transmission will not be good, and the Bluetooth transmission using a computer is realized by an external Bluetooth dongle inserted in a USB port.

### SUMMARY OF THE INVENTION

Accordingly, the primary objective of the present invention is to provide a card reader with wireless transmission wherein a wireless transmission control chip is integrated with a built-in or external circuit board. One side the circuit board includes a connector for a data transmission line. The free end of the transmission line is connected to a USB port of computer mother board. Thereby, the card reader can undergo wireless data transmission through the plastic case, and a conventional external wireless transmitter is not necessary, which reduces the operation cost.

The secondary objective of the present invention is to provide a card reader with wireless transmission wherein the wireless transmission control chip is shared by terminals of various memory cards. Thereby, the number of USB ports is reduced.

It is a further objective of the present invention that the wireless transmission control chip uses one of the known wireless transmission techniques selected from Bluetooth, Ultra Wide Bandwidth (UWB), ZigBee, Wi-Fi, NFC and long-distance WiMAX.

The various objects and advantages of the present invention will be more readily understood from the following detailed description when read in conjunction with the appended drawings.

### BRIEF DESCRIPTION OF THE DRAWINGS

FIG. 1 is a perspective view of a card reader with wireless transmission of the present invention, which can be installed in a computer and serve memory cards of a plurality of specifications.

FIG. 2 is another perspective view of the card reader with wireless transmission in FIG. 1 provided with a case.

FIG. 3 illustrates the installation of the card reader with wireless transmission in FIG. 1 in a computer.

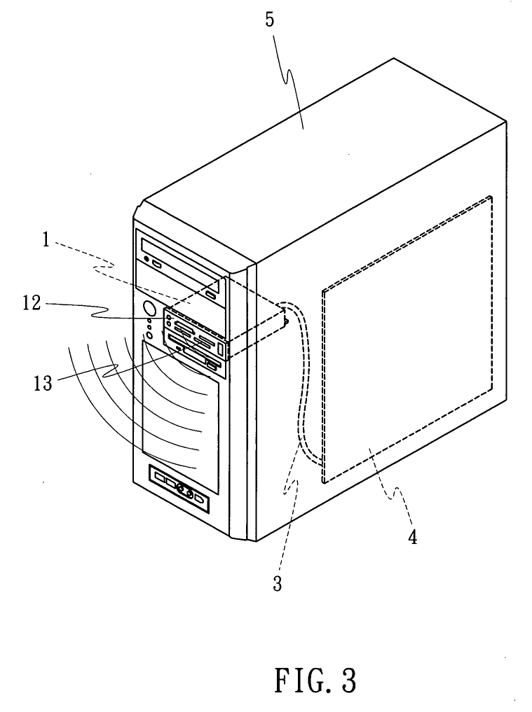

### DETAILED DESCRIPTION OF THE PREFERRED EMBODIMENTS

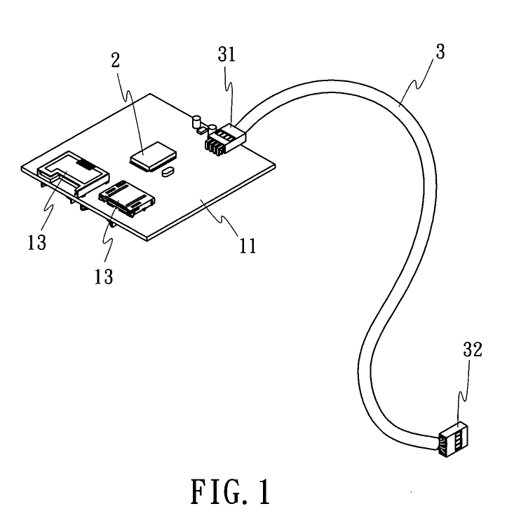

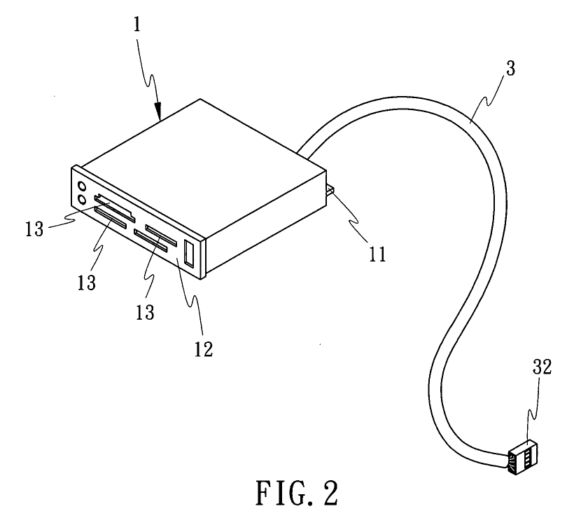

Referring to FIGS. 1 and 2, a card reader with wireless transmission according to the present invention comprises a built-in or external card reader 1 having a circuit board 11 coupled with a wireless transmission control chip 2. One end of the circuit board 11 is connected with a connector for a data transmission wire 31 by welding. The free end of the data transmission wire 3 is provided with another connector 32 for being inserted into a USB port on a computer mother board 4. Thereby, the integrated structure of the wireless transmission control chip 2 and the card reader 1 can send signals outward through the portion of the plastic case 12 enclosing the card reader with wireless transmission on the outer surface of the computer. Therefore, a conventional external wireless transmitter, a Bluetooth device for example, is not necessary, and the occupation number of USB ports can be reduced. Eventually, the production cost can be reduced significantly.

According to the present invention, there is not limit on the form of the card reader 1; it can be an internal device within a computer or an external device. The card reader 1 can have a plurality of memory-card insertion slots 13, as shown in the figures. It can also be a card reader with a single memory-card insertion slot.

The wireless transmission control chip 2 is installed on a circuit board of the card reader 1, with its plastic case extending out of the computer surface. Thereby, the wireless data transmission will not be influenced by the computer case 5. Namely, radio signals can easily pass the portion on the outer wall where the plastic case of the card reader 1 extends, without being hindered by a shielding effect.

The above-mentioned wireless transmission control chip 2 can adopt any of the wireless communication specifications, Bluetooth, UWB, ZigBee, Wi-Fi, NFC and WiMAX (for long distance communication), except that it should match the circuit board 11.

As the card reader with wireless transmission of the present invention is installed in a computer, the built-in capability of wireless communication allows the usage of wireless peripheral device such as a wireless keyboard, a wireless computer, a wireless earphone, a cell phone and a PDA.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A card reader with wireless transmission, comprising:
a circuit board further including a connector for a data transmission wire, a free end of said data transmission wire provided with a plug to be inserted into a USB port attached onto a computer main board;
a wireless transmission control chip mounted on said circuit board; and a plastic case enclosing said circuit board, whereby radio signals from said wireless transmission control chip will be delivered outward without shielding.

2. The card reader with wireless transmission of claim 1 being an internal built-in device within a computer.

3. The card reader with wireless transmission of claim 1 being an externally connected device.

4. The card reader with wireless transmission of claim 1 further including at least one memory-card insertion slot.

5. The card reader with wireless transmission of claim 1 wherein said wireless transmission control chip uses one wireless communication mode selected from Bluetooth, UWB, ZigBee, Wi-Fi, NFC and WiMAX modes.
